(19) United States
(12) Patent Application Publication
(10) Pub. No.: US 2017/0161239 A1
(43) Pub. Date: Jun. 8, 2017

(54) CONTENT SEGMENT DELAYED BEHAVIOR

(71) Applicant: Google Inc., Mountain View, CA (US)

(72) Inventor: Kevan Quincy Newton, Culver City, CA (US)

(73) Assignee: Google Inc., Mountain View, CA (US)

(21) Appl. No.: 13/779,878

(22) Filed: Feb. 28, 2013

(51) Int. Cl. G06F 17/22

(52) U.S. Cl. CPC G06F 17/2247

(57) ABSTRACT

A method, implemented by a processor, for delayed behavior of content segments on a resource, includes embedding, using the processor, a delayed behavior content segment code in a designated area; receiving, using the processor, a request for multi-media content; in fulfillment of the request, receiving, using the processor, an identification of a multi-media content segment to be served in the designated area; and initiating delayed behavior of the multi-media content segment.

### BACKGROUND

When a viewer accesses a Web page, typically all content on that Web page loads and is rendered. However, because of dimensional differences between the viewer's display and the Web page, the viewer initially may not be able to see all the Web page content. As a result the viewer may be required to scroll to see all the Web page content.

Some Web page content includes animation or video that begins playing automatically when the Web page is rendered, whether or not the viewer is viewing the animated/video content. Thus, the viewer may not see all of, or a part of the video or animated content served with the Web page. For example, rich media content may use animation to convey a message. Some or all of the animation may be missed by the viewer if the viewer has to scroll to make the rich media content visible. Similarly, video content may begin playing as soon as the Web page loads, and if the video content is not visible, or is only partially visible to the viewer, the viewer may miss the video content, may not be exposed to the main theme of the video content, or may lose interest in the video content. Thus, rich media and video content may not be as effective as possible in conveying their designed messages when the viewer is required to scroll in order to see the content in its entirety.

### SUMMARY

A method, implemented by a processor, for delayed behavior of content segments on a resource, includes embedding, using the processor, a delayed behavior content segment code in a designated area; receiving, using the processor, a request for multi-media content; in fulfillment of the request, receiving, using the processor, an identification of a multi-media content segment to be served in the designated area; and initiating delayed behavior of the multi-media content segment.

### DESCRIPTION OF THE DRAWINGS

The detailed description refers to the following drawings in which like numerals refer to like items, and in which:

FIG. 1 illustrates an example environment in which content segment delayed behavior is enabled;

FIG. 2 illustrates an example Web page with content segment delayed behavior enabled;

FIG. 3 illustrates an example relationship among a media device display screen, a browser window, and a Web page;

FIG. 4 illustrates an example media device that supports content segment delayed behavior;

FIGS. 5A-5D illustrate example systems that provide content segment delayed behavior; and

FIGS. 6A-6C are flowcharts illustrating example processes for content segment delayed behavior.

### DETAILED DESCRIPTION

Internet Web page content delivery typically involves use of a browser application installed in a viewer's media device. The media device connects to the Internet, and through the hypertext transfer protocol (HTTP), requests Web pages from content servers. When it requests a Web page, the browser loads and renders the Web page according to instructions for the Web page, which typically is written in the Hyper Text Markup Language (HTML) code, such as JavaScript. The rendered Web page content includes text and any images, video, animation, or rich media content.

This process may present problems because, typically, the Web page content initially may not be fully viewable on the viewer's media device. The browser generates a viewable window area, the media device has a set screen size, and the Web page has a set or variable length and/or width. The browser window area may vary based on the media device display area and resolution settings. The browser window may be expanded or reduced in size according to the viewer's dictates, for example, by a browser minimize function. Web pages delivered to this varying environment may have a set size that is larger than the size of the displayed browser window. Moreover, some Web pages, such as those incorporating comments and blog posts, may expand (typically in length) as comments and blogs are posted. Thus, the browser window area may not correspond in size with the Web page area, and the viewer may have to scroll horizontally or vertically to view all of the areas or components (i.e., all the content) of the Web page. Also, the nature of the HTTP protocol may dictate that the code constituting the Web page be completely interpreted by the browser before the browser can display the Web page. Because of these limitations, when the viewer requests a Web page, the browser may load and render the entire Web page, even if the Web page extends beyond the dimensions of the browser window.

One potentially troubling aspect of this process may occur when the requested Web page includes video or animated content. Depending on the length of the video or animated content, the Web page when initially loaded may include only a first portion of the video or animated content. For example, if the Web page includes a 30-seconds long video advertisement, the entire video advertisement may be rendered and begin playing automatically when the Web page is rendered. If the Web page includes a 5-minutes long movie trailer, only the first 30 seconds of the trailer may load initially, and the remaining trailer is buffered in segments in the browser cache and then is displayed with the Web page. In some cases the display is seamless. In other cases, the display is interrupted while the remaining content buffers.

Thus, the process of loading, rendering, and activating video and animated content may be inefficient when the content is completely or partially outside the viewable area of the browser or display screen, and the video and animation features begin playing automatically. This situation can lead to an unsatisfactory viewer experience

This process also affects the potential accuracy of data pertaining to actual perception of delivered content used for various purposes, including proper accounting of advertising usage and placement charges and the measurement and reporting of metadata related to the delivered advertisements.

More particularly, some pricing regimes for Internet-based advertising and content delivery assume that when a Web page is loaded and rendered, a viewer is able to view the advertisement or content in its entirety. That is, an advertiser may pay for advertisements based on loading and rendering of the Web page. For example, Cost Per Thousand Views (CPM) billing for Internet-delivered content assumes that the content always is available to the viewer when the viewer is on the requested Web page. However, because of the above-noted problems, the viewer initially may not be able to view all of the Web page content, including one or more advertisements or content segments. That is, the loading of a Web page does not guarantee all of its content will be in view or available to a viewer for interpretation or influence. Nevertheless, advertisement usage and placement fees may be charged even for advertisements that a viewer may actually never view. The rationale for this pricing scheme may be that because the entire Web page can be loaded and viewed if the viewer takes appropriate action (scrolling), all of Web page's content is available to the viewer.

This situation takes on another dimension when the Web page includes video and/or rich media content segments and advertisements. For example, some video advertisements are designed to play automatically when the Web page is loaded and rendered. But, the position of such a video advertisement on the Web page may be such that the viewer is not able to see enough of or any of the advertisement to be influenced by the advertisement. Advertisements that include video and animation features, for example, may be more likely to capture and hold a viewer's attention. However, such advertisements are more expensive to produce than static advertisements, and an advertiser may be required to pay a higher fee to have such advertisements served with a Web page. Thus, this situation may lead to viewer dissatisfaction and wasted advertising dollars.

To overcome these and related problems with Internet content delivery, disclosed herein are systems and methods that control and may delay content segment behavior. For example, the systems and methods may render and activate or play content automatically (i.e., without a specific action by the viewer) only when and/or to the extent that a designated area of the Web page is completely or substantially within the viewer's browser window dimensions. While the systems and methods are described with application to a Web site or Web page, the systems and methods may apply to other resources, including applications executing on a media device. The systems and methods may apply to Web sites that display advertisements, and rendering and activation of a multi-media advertisement, or may apply to Web sites that display other multi-media content segments, an example of which is a hotel's private Web site that displays a welcome page with a video tour of the hotel that is activated only when the portion of the welcome page is viewable.

As used herein, the term render refers to the process of displaying content so that it may be viewed, heard or otherwise perceived by a viewer communicating electronically using a browser.

As used herein, the term designated area (e.g., of a Web page) refers to an area in which a content provider or advertiser may provide a content segment or advertisement that is to be activated only when the entire area, or a substantial portion of the area, is visible to a viewer.

As used herein, the term content segment includes content that varies with time of display on the viewer's media device, such as audio, video or rich media content, including animation. An advertisement is a specific type of content segment. Advertisements may be or include video. Advertisements may be in a rich media format to include animation. A multi-media advertisement may include audio, video, and/or animation features in addition to text and still graphics, for example.

In an embodiment, a Web page provider designates Web page areas for possible delayed content segment behavior. The Web page provider then makes these designated areas available to advertisers or content providers. Advertisers may provide advertisements, such as video advertisements and rich media advertisements, to be served in the designated areas. In an aspect, the designated areas may be made available through an auction system, and advertisers may bid for the designated areas.

The systems may initiate content behavior in a designated area when the designated area is within the dimensions of the browser window, or alternatively, when the designated area is substantially (e.g., greater than 50 percent) within the dimensions of the browser window. In an aspect, the designated area may include a code segment that determines when the designated area is wholly or substantially viewable in the browser window. Once it makes this determination, the code segment may send a command to render and activate the content segment in the designated area. In this aspect, where the content segment is a video advertisement, a video player plug-in of the browser may begin playing the video advertisements as soon as it is rendered in the designated area. In another aspect, the designated content segment is rendered in the designated area, and the code segment sends a command to initiate display of the content segment. In this aspect, where the content segment is a video advertisement, for example, a video player plug-in of the browser, or a separate video player, may receive a command to begin playing the video advertisement.

The herein disclosed systems include a back-end system for receiving a Web page address (URL), content segment information (which may be in the form of instructions to retrieve one or more content segments, which may be stored in a content server or other storage device, which in turn may be either part of the back-end system or other remotely located systems), Web page designated areas, Web page designated area detection parameters and other Web page data from Web page operators, and a back-end system server with a database for storing records containing such data.

In one aspect, the back-end system generates a code segment, and places the code segment into designated areas on a Web page. The Web page may include one or more such designated areas. In an alternative, the designated areas having the embedded code segments may be positioned such that they would not ordinarily be visible when the Web page is loaded at the browser (e.g., located at the bottom of the Web page). In another alternative, all designated areas are encoded with code segments.

The code segment includes an identification (ID) indicating the designated area is available for display of a video or rich media advertisement, or other content segment. When a viewer requests a Web page having a designated area, the code segment is activated and links to an advertising system. The advertising system allows advertisers to bid to place their video/rich media advertisements, or other content segments, in the designated area. Once such advertisements are identified, for example through an auction process, the Web page and the advertisements are transferred to the viewer's media device and loaded in the media device's browser. However, instead of immediately rendering or activating the advertisements for the designated areas, the browser caches the designated area advertisements. In an embodiment, the browser may render and activate a first frame of the advertisement in the designated area. In this embodiment, the advertisement may be served as two separate but linked files. The content of the first file may be rendered initially with rendering of the Web page 30. The content of the second file may be rendered and the two files activated when the associated designated area becomes wholly or substantially “visible.” In another alternative, no portion of the advertisement is rendered until the designated area is wholly or substantially visible. When the Web page is rendered, any advertisements that are linked to a designated area that is wholly or substantially visible in the browser window may be started automatically. Other advertisements that become wholly or substantially visible only as a result of scrolling are retained in cache until such time as the viewer has scrolled sufficiently to at least partly expose the designated areas.

Once the advertisement (video or rich media) in a designated area has played, the browser sends back to the back-end server an advertisement played message. The advertisement played message then serves as a basis for charging the advertiser for placement of the advertisement. In an example, the video/rich media advertisement may have a length of 30 seconds. In this example, if the advertisement plays for a substantial time, but less than the entire length of the advertisement, the browser may send the advertisement played message. For example, the browser may send the message for an advertisement that plays for ten out of thirty seconds. In another alternative, the browser may send the message if the advertisement plays to conclusion. The browser may send other data with the message, such as a mute signal indicating the viewer has muted the media device, and a pause or a replay signal, if these commands are enabled for display of the advertisement.

Once the Web page is loaded on the viewer's browser, the code segments may operate to detect the presence of their respective designated areas relative to the browser display window. Once the designated area is sufficiently in view, the code segment sends a command to render if necessary and then activate the associated content segment or advertisement from the browser cache. In an embodiment, as a viewer scrolls through a Web page (whether up and down or left and right) or the viewer's browser window dimensions change, the code segments periodically check data from the viewer's browser regarding the viewer's browser window scrolling position and dimensional coordinates. When there is correspondence between the browser window dimensional and scrolling position coordinates and the coordinates for the Web page designated area (which may be partial correspondence or full correspondence), the code segment sends a command to activate the associated content segment or advertisement. The code segment also may record at the Web page 30 data retrieved from the viewer's browser 100 regarding the rendering and activation of the content segment or advertisement.

In an embodiment, once a video or animated advertisement begins playing, should the viewer operate a scrolling feature or a minimize feature such that the video or animated advertisement no longer is wholly or substantially visible, the code segment may send a command to stop or pause playing of the advertisement. If the advertisement has not played sufficiently to trigger a charge to the advertiser, then the browser may not send the advertisement played signal to the back-end server.

The processes executed by the herein disclosed systems may involve use of information that in some respect identifies a device the viewer uses to access the television programming. For example, when a viewer uses an Internet browser to access a Web site, a Web server may create a random identification (ID) that identifies the browser and may cause the random ID to be stored on the viewer's device.

In situations in which the systems disclosed herein collect personal information about viewers, or may make use of personal information, the viewers may be provided with an opportunity to control whether programs or features collect viewer information (e.g., information about a viewer's social network, social actions or activities, profession, a viewer's preferences, or a viewer's current location), or to control whether and/or how to receive advertisements from an ad server that may be more relevant or of interest to the viewer. In addition, certain data may be treated in one or more ways before it is stored or used, so that personally identifiable information is removed. For example, a viewer's identity may be treated so that no personally identifiable information can be determined for the viewer, or a viewer's geographic location may be generalized where location information is obtained (such as to a city, ZIP code, or state level), so that a particular location of a viewer cannot be determined. Thus, the viewer controls how information is collected about the viewer and used by a server.

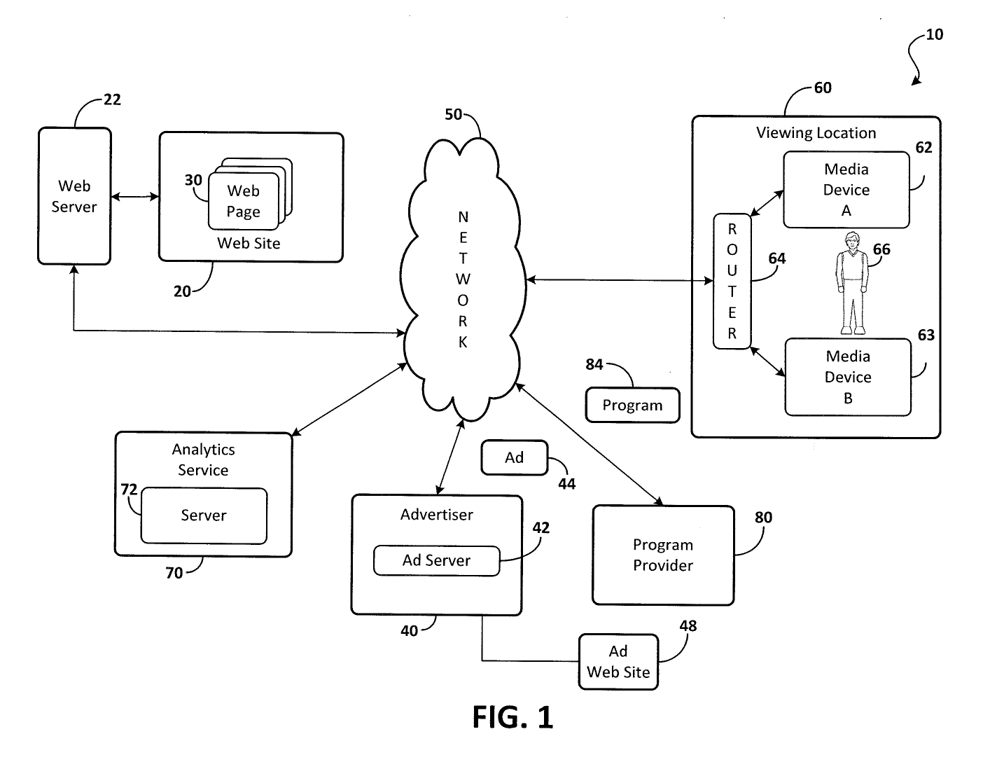

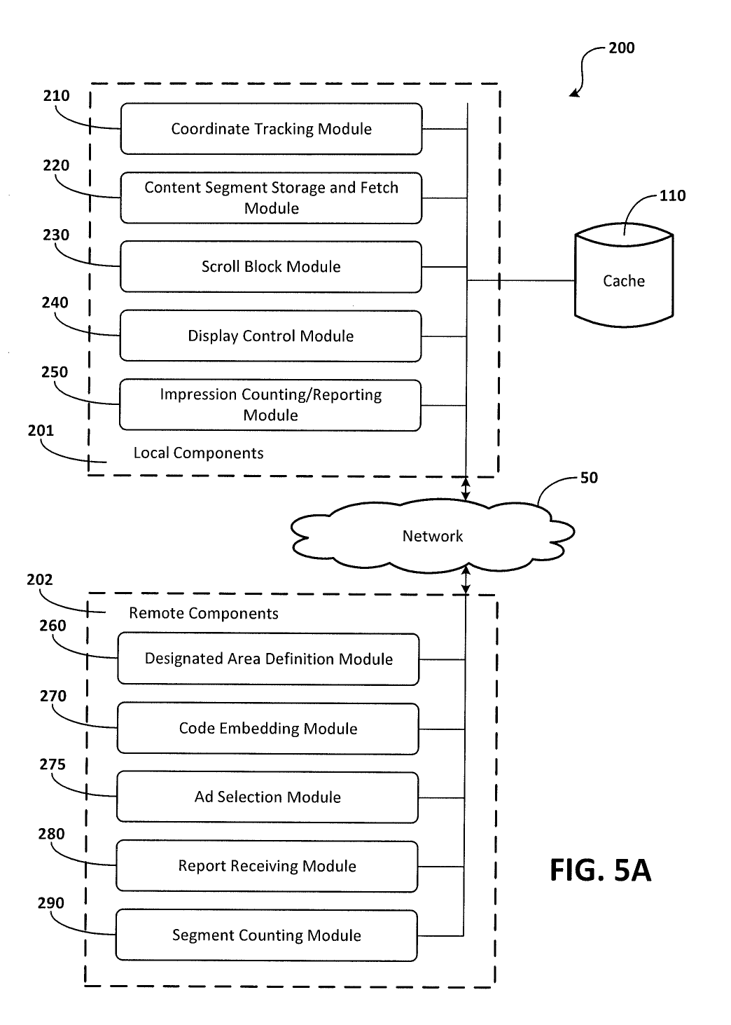

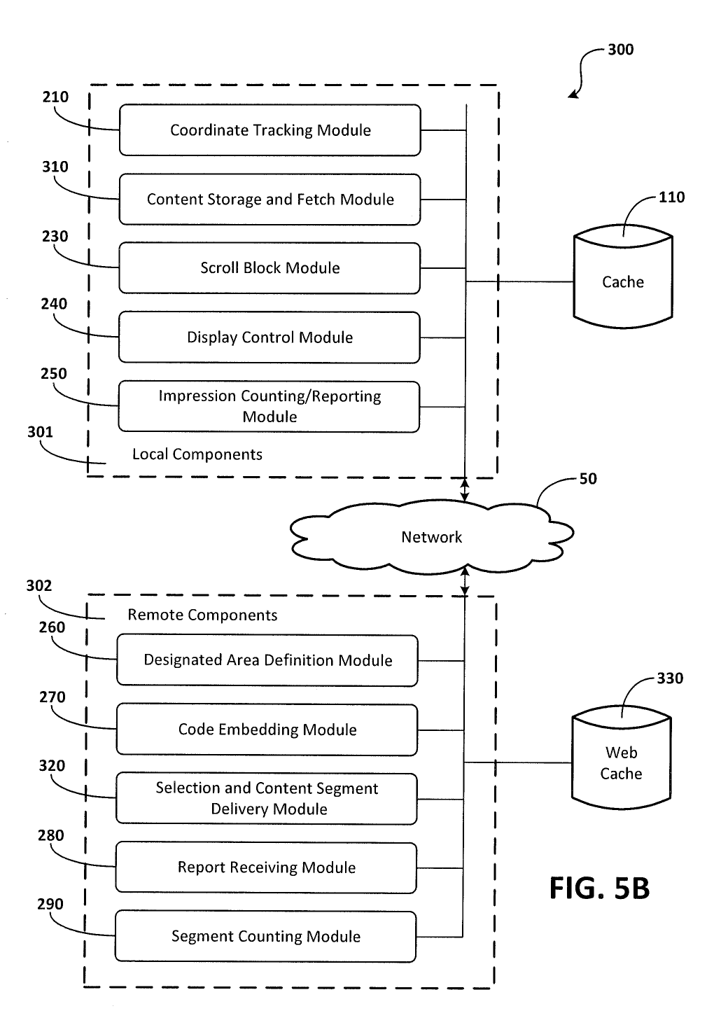

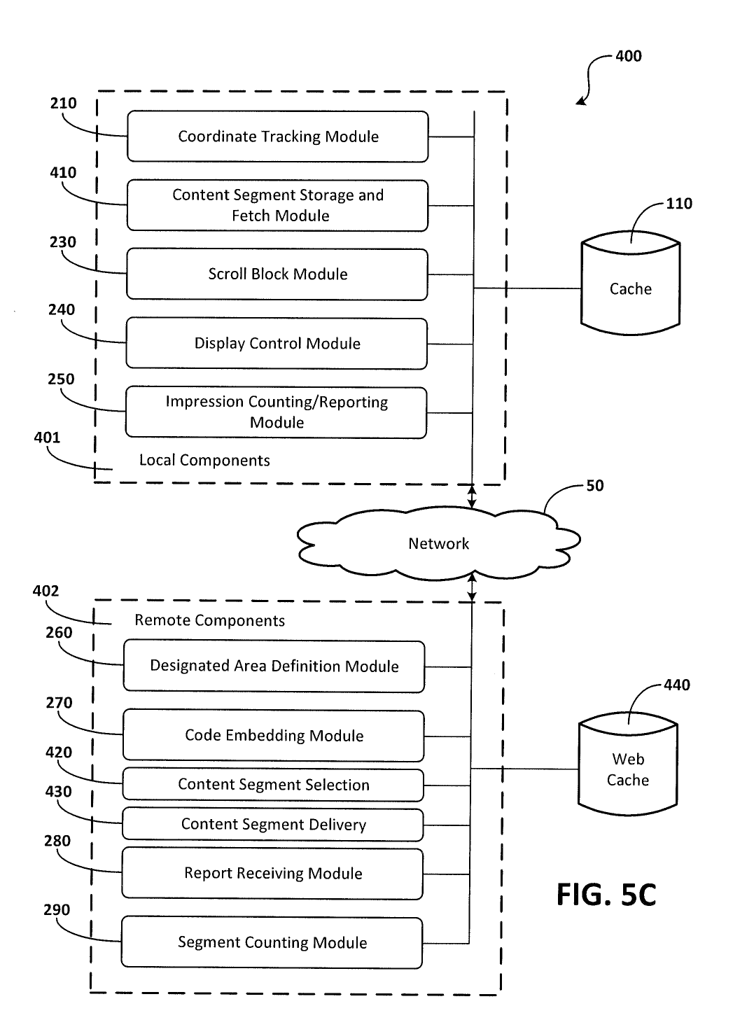

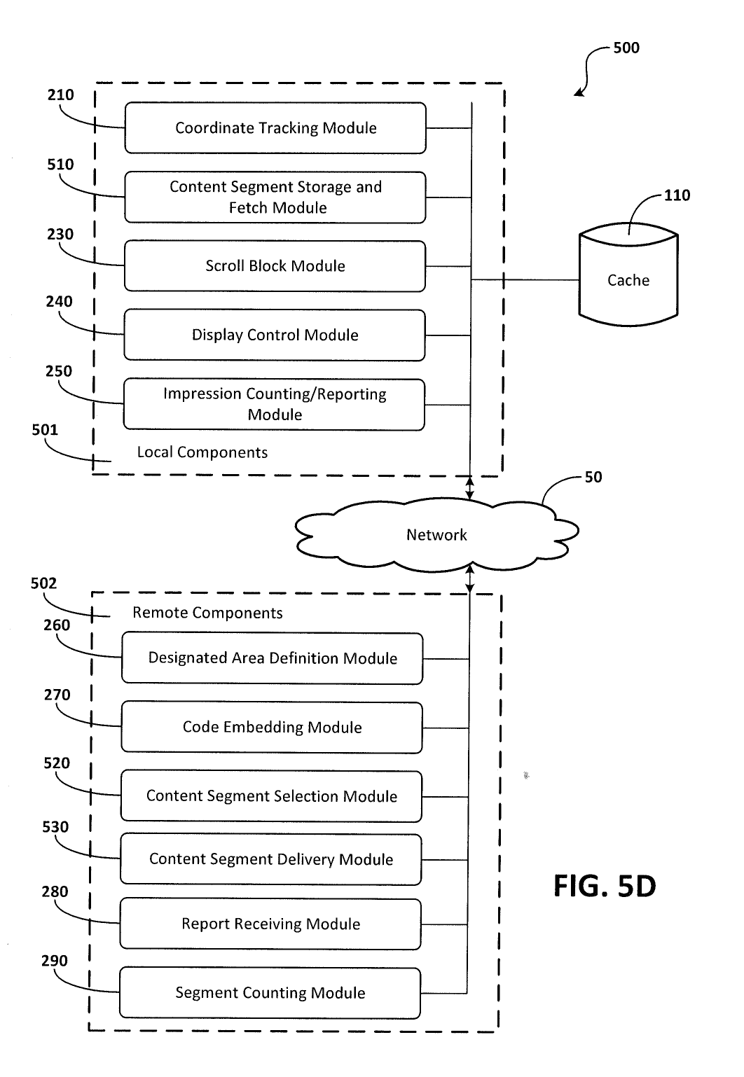

FIG. 1 illustrates an environment in which display of Web page content segments may be delayed until a designated area in which the content segment is to be shown is visible to a viewer. In FIG. 1, environment 10 includes Web site 20, advertiser 40, viewing location 60, analytics service 70, and program provider 80, all of which communicate over network 50. The Web site 20 is hosted on Web server 22. The Web site 20 may be an Internet search Web site; a social network Web site; a commercial Web site selling products and services, and providing information about the products and services; and an online service such as an online banking service or an online dating service. The Web site 20 includes Web pages 30. The Web server 22 provides links to enable navigation among the Web pages 30. The Web server 22 also may display, on any of the Web pages 30, links to other Web sites. The Web site 20 may display programs created and provided by program provider 80 and advertisements provided by advertiser 40. The Web server 22 may incorporate components of a delayed content behavior system (not shown in FIG. 1), as is discussed with respect to FIGS. 5A-5D. Alternately, these components may be implemented at another back-end server.

The advertiser 40 operates ad server 42 to provide advertisements 44 (i.e., content segments) that are served at the Web pages 30. The advertiser 40 may represent a single company or entity, a group of related companies, or a group of unrelated companies (e.g., the advertiser 40 may operate as an ad broker). The advertiser 40 may operate the ad server 42 to provide one or more Web sites 48. The advertisements 44 provided for display on the Web pages 30 may be static advertisements or non-static advertisements. The advertisements 44 may include audio, video, and animation features. The advertisements 44 may be in a rich media format. The advertiser 40 may provide an advertising campaign that includes both static and non-static advertising. The static advertisements and non-static advertisements may complement each other; that is, the static advertisements and the non-static advertisements may be related to the same product or service. The advertisements 44 may be displayed on a Web page 30 at the same time that a program is being displayed on the Web page 30. The advertisements 44 may be shown as a video overlay of a program, before and/or after display of a program, and during pauses in the program. The advertisements 44 may be served in specific locations of the Web page 30 while the program is displayed in a different location of the web page 30. The advertisements 44 may change during display of a program.

The advertisements 44 may include links to other Web pages and other Web sites, including Web sites 48. For example, an advertisement for a car may include a link to a car manufacturer's Web site. A viewer viewing a program may “click” on the advertisement and be redirected to the car manufacturer's Web site.

The network 50 may be any communications network that allows the transmission of signals, media, messages, voice, and data among the entities shown in FIG. 1, including radio, linear broadcast (over-the-air, cable, and satellite) television, on-demand channels, over-the-top media, including streaming video, movies, video clips, and games, and text, email, and still images, and transmission of signals, media, messages, voice, and data from a media device to another media device, computer, or server. The network 50 includes the Internet, cellular systems, and other current and future mechanisms for transmission of these and other media. The network 50 may be both wired and wireless.

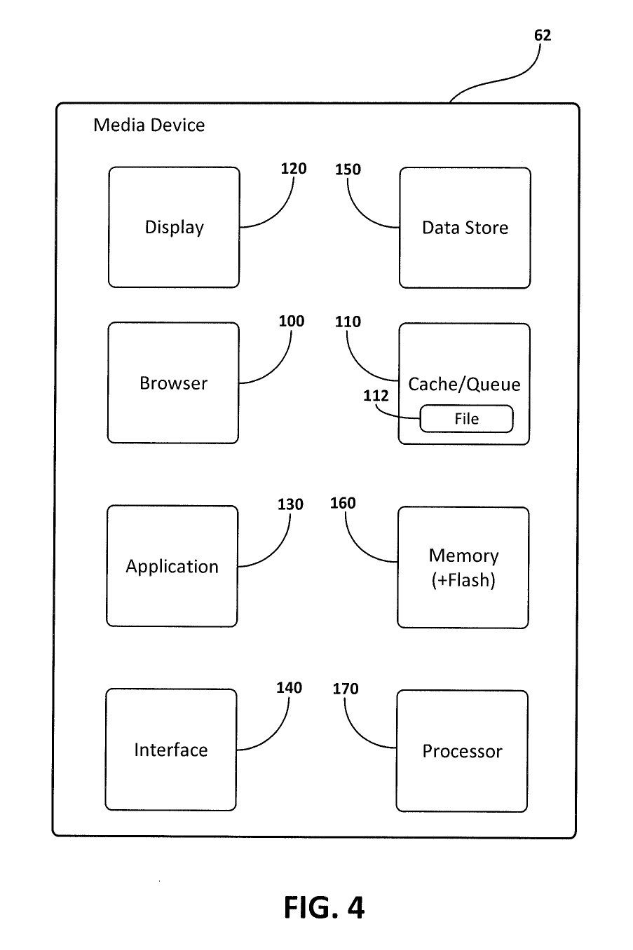

The viewing location 60 may be the residence of an individual viewer, such as viewer 66, who operates media devices 62 and 63 to access, through router 64, resources such as the Web sites 20. The media devices 62 and 63 may be fixed or mobile. For example, media device 62 may be an Internet connected “smart” television (ITV); a “basic” or “smart” television connected to a set top box (STB) or other Internet-enabled device; a Blu-ray™ player; a game box; and a radio, for example. Media device 63 may be a tablet, a smart phone, a laptop computer, or a desk top computer, for example. The media devices 62 and 63 may include browsers, such as browser 100 (see FIG. 4). The browser 100 may be a software application for retrieving, presenting, and traversing resources such as at the Web site 20. A resource may be identified by a Uniform Resource Locator (URL) and may be a Web page, image, video, or other content. The URL may allow the browser 100 to connect to the Web site 20. Hyperlinks present in resources enable the viewer 66 to navigate the browser 100 to related resources. The viewer 66 may operate the browser 100 to search for Web sites related to specific topics or to search for a specific Web site by URL. The media devices 62 and 63 also may include applications 130 (see FIG. 4). The viewer 66 may cause the media devices 62 or 63 to execute an application 130, such as a mobile banking application, to access online banking services. The application 130 may involve use of a browser or other means, including cellular means, to connect to the online banking services. Once connected to the Web site 20, the media devices 62 and 63 may allow viewing of content such as video programs and static images generated by the program provider 80 and displayed on the Web pages 30 at the Web sites 20. The video programs and static images may include slots or spaces into which content segments such as advertisements may be placed. When such a video program or static image is viewed on the media devices 62 or 63, the media device may send an advertisement (ad) request, which is received at the advertiser 40, and which may be answered with an advertisement 44.

Returning to FIG. 1, the media devices 62 and 63 may communicate through the network 50 directly to the analytics service 70. For example, an application on the media device 62 may be a game. The individual game moves (clicks) made by the viewer 66 in playing the game may be sent directly to the analytics service 70 by the media device 62.

The analytics service 70 includes analytics server 72. The analytics service 70 may operate in conjunction with Web site operators to collect, analyze, and report information and data related to visits to Web sites by viewers 66. The analytics service 70 may be part of the Web site 20, the advertiser 40, or a separate entity. The analytics service 70 collects, analyzes and reports on data and information related to visits to the Web site 20, operation of applications, and other reported activity.

The program provider 80 provides content, in the form of programs 84, which may be displayed on the Web pages 30 and viewed and/or heard by the viewer 66 using the media devices 62 and 63.

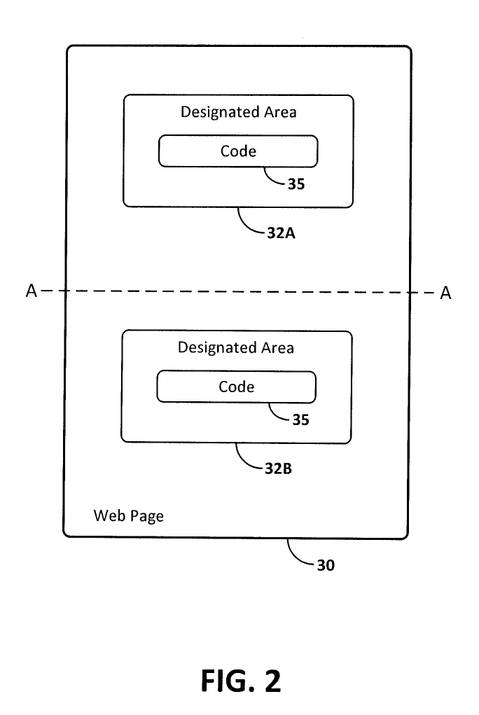

FIG. 2 illustrates the Web page 30 of FIG. 2 with content segment delayed behavior enabled. In FIG. 2, the Web page 30 includes designated areas 32A and 32B. The designated areas may be used to serve and display multi-media advertisements; that is, advertisements with audio, video, and/or animation features in addition to text and still graphics, for example. Designated area 32A is positioned near a top of the Web page 30 and designated area 32B is positioned near a bottom of the Web page 30. Both designated areas 32A and 32B include code segments 35. As noted, the code segments 35 track the position (coordinates) of their respective designated areas relative to the browser window and/or display screen coordinates, and send commands to activate associated content segments in the designated areas when the coordinates of the respective designated areas wholly or substantially correspond to the coordinates of the browser window 101 and/or display 120. In an embodiment, the code segment includes a first instruction to retrieve the identified multi-media advertisement from a storage location when the coordinates of the designated area are wholly or substantially within a viewing area of a browser window, a second instruction to render the retrieved multi-media advertisement in the designated area, a third instruction to activate the rendered multi-media advertisement, and a fourth instruction to monitor and report play of the activated multi-media advertisement.

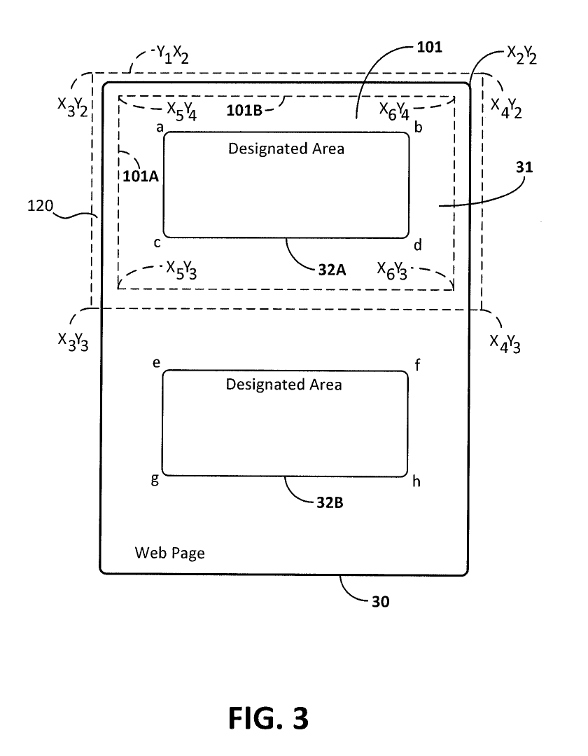

FIG. 3 illustrates an example relationship among a media device display screen, a browser window, and a Web page. In FIG. 3, Web page 30 has the coordinates X₁,Y₁; X₁,Y₂; X₂,Y₂. Display 120 (of media device 62—see FIG. 4) has the coordinates X₃,Y₃; X₄,Y₃; X₃,Y₂; X₄,Y₂: Browser window 101 has the coordinates X₅,Y₃; X₆,Y₃; X₅,Y₄; X₆,Y₄. In an embodiment, the browser 100 may size the browser window 101 to coincide with the display 120. However, the viewer 66 may adjust the size of the browser window 101 by, for example, minimizing the browser window 101 or moving a vertical boundary 101A or horizontal boundary 101B of the browser window 101. A portion 31 of Web page 30 appears in browser window 101, which in turn is displayed in display 120 of media device 62. As can be seen, the Web page 30 is larger than the browser window 101 and the display 120, so that only portion 31 of the Web page 30 is within the browser window dimensions and scrolling position shown on the media device's display 120. As can be further seen, the Web page 30 includes a designated area 32A that is inside the browser window 101. That is, the coordinates a, b, c, d are within the coordinates X₅,Y₃; X₆,Y₃; X₅,Y₄; X₆,Y₄. The Web page 30 also includes a designated area 32B that is outside the browser window 101. That is, the coordinates e, f, g, h are outside the coordinates X₅,Y₃; X₆,Y₃; X₅,Y₄; X₆,Y₄. Hence, the viewer 66 cannot see a content segment associated with the designated area 32B without scrolling. The herein disclosed systems and methods then may operate so as to delay behavior of a content segment in designated area 32B until the coordinates of the designated area 32B wholly or substantially correspond to the coordinates of the browser window 101.

FIG. 4 illustrates an example media device that supports content segment delayed behavior. In FIG. 4, media device 62 includes browser 100, cache 110, display 120, application 130, interface 140, data store 150, memory 160, and processor 170. The browser 100 may be a software application for retrieving, presenting, and traversing resources such as at the Web site 20. Hyperlinks present in resources enable the viewer 66 to navigate the browser 100 to related resources. When operating browser 100, the viewer 66 may scroll up or down, left or right in order to view the entire Web page 30. The browser 100 enables the viewer 66 to access, retrieve and view documents and other resources on the Internet. The browser 100 also may be used to access information provided by Web servers in private networks or files in file systems.

The browser 100 may include computer code to store a file 112 and record viewer actions. The browser 100 may store information related to Web site visits, including the URL of the Web site, date and time of visit, length of visit (or start and stop time of visit), and actions taken by the viewer 66 during the visit. The browser 100 may store information that unambiguously identifies the viewer 66. However, the browser 100 may do so without storing any personally-identifiable information regarding the viewer 66.

In another example, when a viewer 66 visits the Web site 20 (or uses an application 130) the file 112 stores a random ID of the browser 100 and no other Web site data. In this example, the contents of the file 112 may be provided to the analytics service 70 either directly from the browser 100 or by way of the Web server 22. If the viewer 66 logs on to the Web site 20, the Web server 22 may use this log on to correlate the viewer 66 with the random ID, and may send this correlation to the analytics service 70. The Web server 22 also may send any “hits” that occur at the Web site 20 during the visit.

The cache 110 stores information related to delayed behavior content segments, such as video and rich media advertisements. The information may include the URLs of the content segments, as well as other data. In an embodiment, the cache 110 also stores the entire video and rich media advertisements associated with designated areas in an accessed Web page 30. However, as is described later, the information related to the delayed behavior content segments, and the content segments themselves, may be stored in a cache external to the media device 62. For example, the data may be cached at the Web server 22, the ad server 42, or the analytics server 72.

The display 120 includes a display screen and the programming and hardware to display the content, content segment references, and data and information stored in the cache 110.

The application 130 may be installed on the media device 62 to perform a specific function. For example, the application 130 may be a mobile banking application.

The interface 140 includes a data entry device such as a keyboard, a mouse, a speaker, and a voice command input such as a microphone. Operation of the interface 140 may provide the viewer 66 with audio and visual features. The interface 140 also includes scrolling features that allow the viewer 66 to change a position of the displayed Web page 30 relative to the display 120 and the browser window 101.

The data store 150 is or includes a computer-readable storage medium. The data store 150 may be embodied in many forms, such as a hard disk drive, a magnetic disk drive, an optical disk drive, a tape drive, or another type of computer readable media which can store data that are accessible by the processor 170. The data store 150 may store programming to operate the media device 62 and applications that execute on the media device 62. The data store 150 also may store components of a delayed behavior content segment system, which is described in more detail with respect to FIG. 5.

The memory 160 stores programming for execution by the processor 170 to operate the media device 62.

When visiting the Web site 20, the viewer 66 may register with and log on to the Web site 20 by providing a viewer-created identification (hereafter, a user ID) and a password and/or pass code, for example. Alternately, the viewer 66 may access the Web site 20 without registering and without logging on. Whether or not logged on, the viewer 66 may take actions that may be recorded as viewer actions at the Web site 20 such as clicking on a link, filling a shopping cart, down loading content, uploading content, purchasing a product or service, or filling out a form, for example. These and other viewer actions then may be sent from the Web server 22 to the analytics service 70.

When using an application 130, the viewer 66 may make various selections that also may be recorded by the Web server 22 and analyzed at the analytics service 70. For example, the viewer 66 may select a pop-up or overlay advertisement presented during execution of the application 130. The selection may be recorded and sent to the analytics service 70 as an impression.

Similar to the browser 100, the application 130 may store in file 112 viewer identification information, Internet address information, and other data and information related to use of the application 130.

FIGS. 5A-5D illustrate examples of systems that provide content segment delayed behavior. In general, the systems include components that are executed by processors. The processors may be installed on a local media device or a back-end server, such as the servers 22, 42, and 72, or another server, for example.

In FIG. 5A, content segment delayed behavior system 200 (indicated by the dotted lines) includes local components 201, which are or may be installed on the visitor's media device 62. In an embodiment, the local components 201 are or may be installed as a plug-in to the browser 100. The local components 210 may be installed as a plug-in to the browser 100 from a removable storage device (i.e., a computer-readable storage medium) or by download over the communications network 50 (e.g., from a back-end server), or may come pre-installed with the browser 100. The browser 100 may communicate with the local cache 110. The system 200 also includes remote components 202, which may be installed at a remote server such as one or more of the Web server 22, ad server 42, or analytics server 72, or other back-end server. The back-end server may communicate with the media device 62 by way of the network 50.

The local components 201 include coordinate tracking module 210, content segment storage and fetch module 220, scroll block module 230, display control module 240, and impression counting/reporting module 250. The remote components 202 include designated area definition module 260, code embedding module 270, ad selection module 275, report receiving module 280 and segment counting module 290.

The coordinate tracking module 210 detects any Web page designated areas upon initial load of the Web page 30. The module 210 may detect such designated areas by detecting the code segment 35 embedded in the designated area. The module 210 interprets the code, including the coordinates of the designated area relative to a reference point on the Web page 30, and a pointer or link to the storage locale of the content segment, in this case to the local cache 110, and the content segment ID. The module 210 then tracks the coordinates of any designated areas on the Web page whose content segment is cached in the cache 110 relative to the coordinates of the browser window 101 and the display 120 as the viewer 66 scrolls the browser window 101. When these coordinates coincide, or substantially coincide, the module 210 reads the code segment 35 embedded in the designated area and sends a message to activate the associated content segment.

The content segment storage and fetch module 220 stores content segments that are designated for delayed behavior in the cache 110. In an embodiment, the entire delayed behavior content segment is loaded into the cache 110 with the corresponding Web page 30. However, rather than being immediately displayed in the browser window 101, the module 220 retains the delayed behavior content segment in the cache 110 and only a pointer to the cache contents is rendered with the initial rendering of the Web page 30, or in an alternative, a first frame and the pointer, are rendered. Then, when the coordinates of the associated designated area coincide, or substantially coincide with those of the browser window 101 or display 120, the module 220 receives the message from the tracking module 210 and fetches the delayed behavior content segment from the cache 110 for behavior in the browser 100.

Once the delayed behavior content segment is rendered in the browser 100, the segment's video or animated features may be activated. For example, upon rendering of the delayed behavior content segment, the module 220 may send a signal to the display control module 240, which in turn signals the video player to initiate or resume playing the content segment. In this way, a video player plug-in to the browser 100 may cause a video advertisement to be played once the video advertisement is rendered.

The scroll block module 230 may be optionally implemented and/or may be disabled by the viewer 66. The scroll block module 230 may disable browser scrolling or minimization that would preclude viewing of an activated content segment until the segment has played a sufficient time to count as an impression. The time may be set as a percentage of the length of the content segment. For example, scrolling may be inhibited until after 15 seconds of a 30 second video advertisement have played.

The display control module 240 receives signals from the modules 220, 230 and 250 to play or pause playing of a delayed behavior content segment. The module 240 also may be optionally implemented to allow the viewer 66 to pause, replay, or fast forward the delayed behavior content segment. The module 240 also may record operation of a mute control that prevents the playing of audio from the delayed behavior content segment. The module 240 records these viewer actions and provides the actions to the impression counting/reporting module 250.

The impression counting/reporting module 250 determines when a delayed behavior content segment has played for a sufficient time. For example, the impression counting/reporting module 250 determines when a video advertisement has played for a time sufficient to count as an impression. This time may be set between the advertiser 40 and the Web site operator, for example. The time may be 50 percent of the length of the video advertisement, for example. Once the time limit has been satisfied, the module 250 counts the display of the video advertisement as an impression. The module 250 also receives any (including optional) signaling from the module 240. The module 250 reports the impression count and any associated signaling from the module 240 to a remote server such as the analytics server 72. For example, the module 250 may report that the audio content was muted, the play was paused by the viewer 66, play was paused by the module 240 because the browser window 101 was minimized, or a new tab was opened with the browser 100.

The remote components 202, as noted, include designated area definition module 260, code embedding module 270, ad selection module 275, report receiving module 280 and segment counting module 290. The designated area definition module 260 allows a Web site operator to designate areas within a Web page 30 that may be used for delayed behavior of content segments. The definition of the areas may be completed by use of a simple X-Y coordinate system relative to a reference point on the Web page 30 (e.g., the top left of the Web page 30).

In an embodiment, when the browser 100 first accesses a Web page having designated areas, the module 260 may detect if the browser 100 has the capability of delayed behavior of content segments. If delayed content segment behavior is not implemented on the browser 100, the designated area definition module 260 may operate to push the local components 201 to the media device 62 for plug-in to the browser 100. In an embodiment, the module 260 may first transmit a request message to install the local components 201 as a plug-in to the browser 100.

The code embedding module 270 allows the Web site operator to position a code segment 35 within the designated area, or optionally outside the designated area, so as to trigger delayed content segment behavior for a content segment within the designated area. The code segment 35 may identify the designated area as able to display a delayed behavior content segment. That is, when the viewer 66 access a Web page 30 having a designated area, the code segment 35 signals the ad server 42 to select a video advertisement or rich media advertisement that may be intended for delayed behavior. The code segment 35 also may specify the percentage view of the designated area that is necessary to trigger the delayed behavior.

The ad selection module 275 sends an ad request to the ad server 42 so as to receive a delayed behavior content segment for serving in a designated area. The module 275 may interpret the code segment 35 of the designated area and provide appropriate data to the ad server 42 to enable selection (e.g., by auction) of an advertisement. The data may include the random ID of the browser 100, the identification of the designated area, the length limits of an advertisement, the impression counting threshold (e.g., 15 out of 30 seconds) and other relevant data. The module 275 then receives a selected advertisement and provides the selected advertisement to be served with the Web page 30.

The report receiving module 280 receives impression counts and other data reported by the impression counting/reporting module 250. These data then may be used by the Web server 22 or analytics server 72 to determine how much to charge the advertiser 40 for delayed behavior display of the advertisement.

The segment counting module 290 optionally may be used to limit the number of displays of the same video or rich media advertisement by a specific browser. As noted above, each browser, when accessing a Web page, may be given a unique, random ID. Any video or rich media advertisements displayed by this browser may be repeated. However, repeating advertisements too many times may not be cost effective. Accordingly, the module 290 may be set to prevent repeating a particular advertisement after a specified number of impressions are counted over a specified calendar interval.

In the system 200 of FIG. 5A, as noted, local components 201 execute on the viewer's media device 62 to cache delayed behavior content segments in the local cache 110. For a short (e.g., 30-second) advertisement, the entire contents may be initially buffered in the cache 110. However, as the length of the delayed behavior content segment increases (e.g., greater than 30 seconds), some portions of that content segment may be retrieved from the ad server 42 over time and sequentially buffered in the cache 110 and then rendered in the designated area.

FIG. 5B illustrates another example system for delayed content segment behavior. In FIG. 5B, system 300 is shown as components within the dotted lines. The system 300 includes local components 301 installed, for example at the viewer's media device 62, and more particularly on the browser 100 of the media device 62. The system 300 also includes remote components 302 installed on one or more remote servers such as the servers 22, 42, and 72, or other back-end server. The browser may store data in and retrieve data from the local cache 110. The back-end server may store data in and retrieve data from Web cache 330. The browser 100 also may retrieve data from the Web cache 330. The back-end server and media device 62 may communicate by way of network 50.

The local components 301 include coordinate tracking module 210, content segment storage and fetch module 310, scroll block module 230, display control module 240, and impression counting/reporting module 250. The remote components 302 include designated area definition module 260, code embedding module 270, report receiving module 280, segment counting module 290, and selection and content segment delivery module 320.

In the system 300, the coordinate tracking module 210, optional scroll block module 230, optional display control module 240, impression counting/reporting module 250, designated area definition module 260, code embedding module 270, report receiving module 280, and segment counting module 290 operate in a manner similar to the corresponding modules of system 200. However, rather than caching the delayed behavior content segment at the local cache 110, the system 300 caches the delayed rendering content segment in a storage device separate from the browser 100. For example, the delayed behavior content segment may be cached external to the media device 62. That is, in the system 300, rather than using the cache 110 of the media device 62, a remote server (e.g., the ad server 42) employs a Web cache 330 to temporarily store (cache) the delayed behavior content segment. In one alternative, the Web cache 330 is incorporated as part of the ad server 42. In another alternative, the cache 330 may be part of a cloud storage system. In still another alternative, the cache 330 is part of the viewer's Internet Service Provider (ISP) network.

In an embodiment of the system 300, when the browser 100 accesses a Web page 30, all delayed behavior content segments for that Web page 30 are selected (e.g., by auction), identified, and cached in the cache 330. In this alternative, the content segment storage and fetch module 310, incorporated into the browser 100, sends a request to the remote server hosting the Web cache 330 when an associated designated area's coordinates wholly or substantially coincide with the browser window's coordinates. The remote server, using the selection and content segment delivery module 320 then selects and subsequently sends the associated delayed behavior content segment directly to the media device 62 where it is loaded into the local cache 110 and rendered in the designated area of the displayed Web page 30.

FIG. 5C illustrates another example system that supports delayed behavior of content segments. In FIG. 5C, system 400 is indicated by the dotted lines. The system 400 includes local components 401 installed, for example at the viewer's media device 62, and more particularly on the browser 100 of the media device 62. The system 400 also includes remote components 402 installed on one or more remote servers such as the servers 22, 42, and 72, or another back-end server. The browser 100 may store data in and retrieve data from local cache 110. The back-end server may store data in and retrieve data from the Web cache 440. The browser 100 also may retrieve data from the

Web cache 440. The media device 62 and the back-end server may communicate by way of the network 50.

The local components 401 include coordinate tracking module 210, content segment storage and fetch module 410, scroll block module 230, display control module 240, and impression counting/reporting module 250. The remote components 402 include designated area definition module 260, code embedding module 270, report receiving module 280, segment counting module 290, content segment selection module 420 and content segment delivery module 430.

In the system 400, the coordinate tracking module 210, optional scroll block module 230, optional display control module 240, impression counting/reporting module 250, designated area definition module 260, code embedding module 270, report receiving module 280, and segment counting module 290 operate in a manner similar to the corresponding modules of systems 200 and 300. However, rather than caching the delayed behavior content segment at the local cache 110, the system 400 caches the delayed behavior content segment in a storage device separate from the browser 100. For example, the delayed behavior content segment may be cached external to the media device 62. That is, in the system 400, rather than using the cache 110 of the media device 62, a remote hosting server (e.g., the ad server 42) employs a Web cache 440 to temporarily store (cache) the delayed behavior content segment. In one alternative, the Web cache 440 is incorporated as part of the ad server 42 or the Web server 22. In another alternative, the cache 440 may be part of a cloud storage system. In still another alternative, the cache 440 is part of the viewer's Internet Service Provider (ISP) network.

In an embodiment of the system 400, when the browser 100 accesses a Web page 30, the browser 100 loads and renders all components of the Web page 30 with the exception of those components (i.e., delayed behavior content segments) retained in the Web cache 440. When the coordinates of a designated area wholly or substantially coincide with those of the browser window 101, the browser 100 requests the associated delayed behavior content segment for the server hosting the Web cache 440. The hosting server then sends the requested delayed behavior content segment to the browser 100, which automatically stores the segment in the local cache 110 and renders the segment in the designated area. Note that some designated areas may be immediately viewable in the browser window 101 with the rendering of the Web page 30. In this situation, the browser immediately (i.e., coincident with rendering the Web page 30) sends the request to the hosting server.

FIG. 5D illustrates another example system that supports delayed behavior of content segments. In FIG. 5D, system 500, indicated by the dotted lines, includes local components 501 installed, for example at the viewer's media device 62, and more particularly on the browser 100 of the media device 62. The browser 100 may store data in and retrieve data from the local cache 110. The system 500 also includes remote components 502 installed on one or more remote servers such as the servers 22, 42, and 72, or another back-end server. The media device 62 and the back-end server may communicate by way of the network 50.

The local components 501 include coordinate tracking module 210, content segment storage and fetch module 510, scroll block module 230, display control module 240, and impression counting/reporting module 250. The remote components 502 include designated area definition module 260, code embedding module 270, report receiving module 280, segment counting module 290, content segment selection module 520 and content segment delivery module 530.

In the system 500, the coordinate tracking module 210, optional scroll block module 230, optional display control module 240, impression counting/reporting module 250, designated area definition module 260, code embedding module 270, report receiving module 280, and segment counting module 290 operate in a manner similar to the corresponding modules of systems 200, 300 and 400. However, rather than caching the delayed behavior content segment at the local cache 110, the system 500 serves delayed behavior content segments as the designated areas of the Web page 30 become “viewable.”

More particularly, in an embodiment of the system 500, when the browser 100 accesses a Web page 30 having designated areas for delayed behavior content segments, the browser 100 loads and renders all the contents of the Web page 30 with the exception of the delayed behavior content segments. Then, when a designated area of the Web page 30 becomes viewable, the content segment storage and fetch module 510 sends an ad request to the ad server 42. The content segment selection module 520 receives the ad request and selects an advertisement. Then the content segment delivery module 530 returns the selected advertisement to the content segment fetch and storage module 510. The module 510 then stores the selected advertisement in the cache 110 and the browser 100 renders and activates the advertisement.

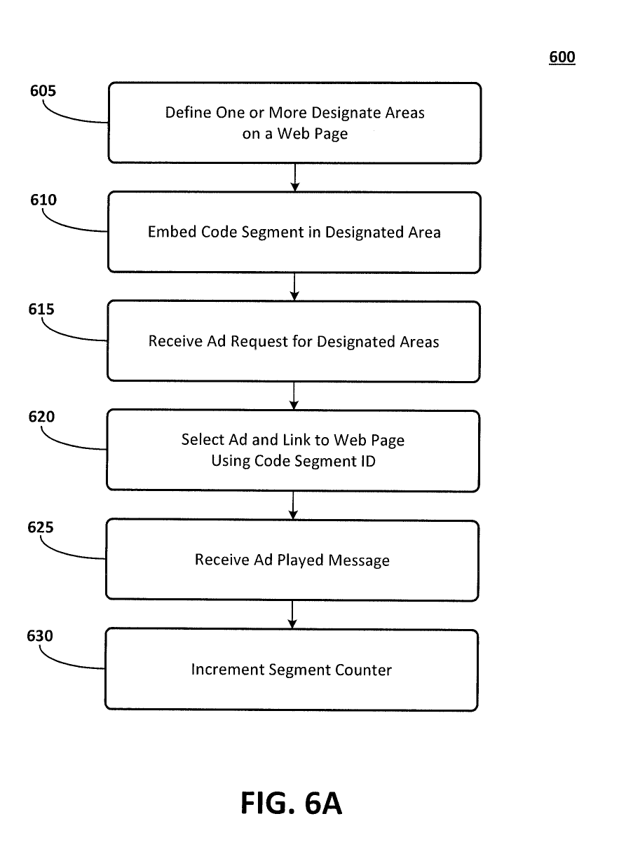

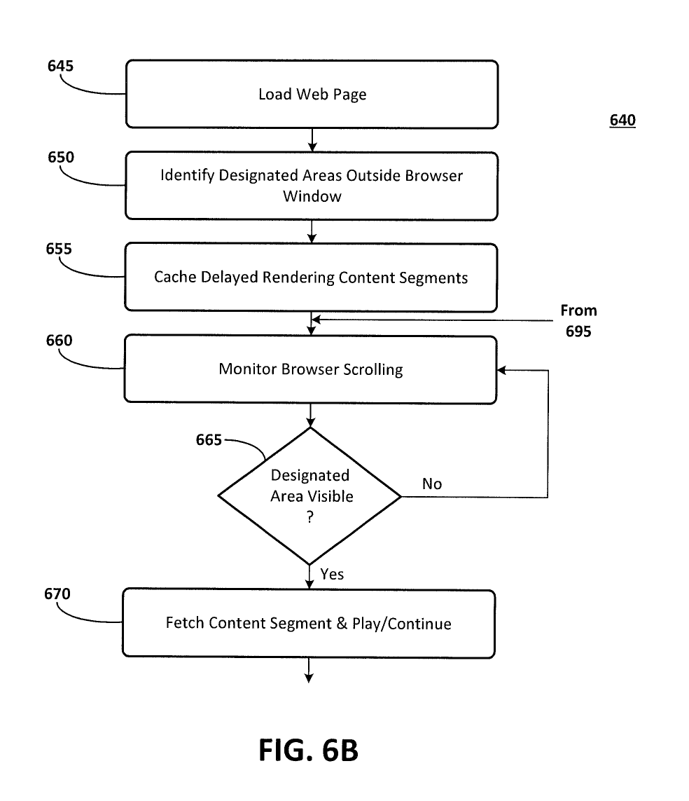

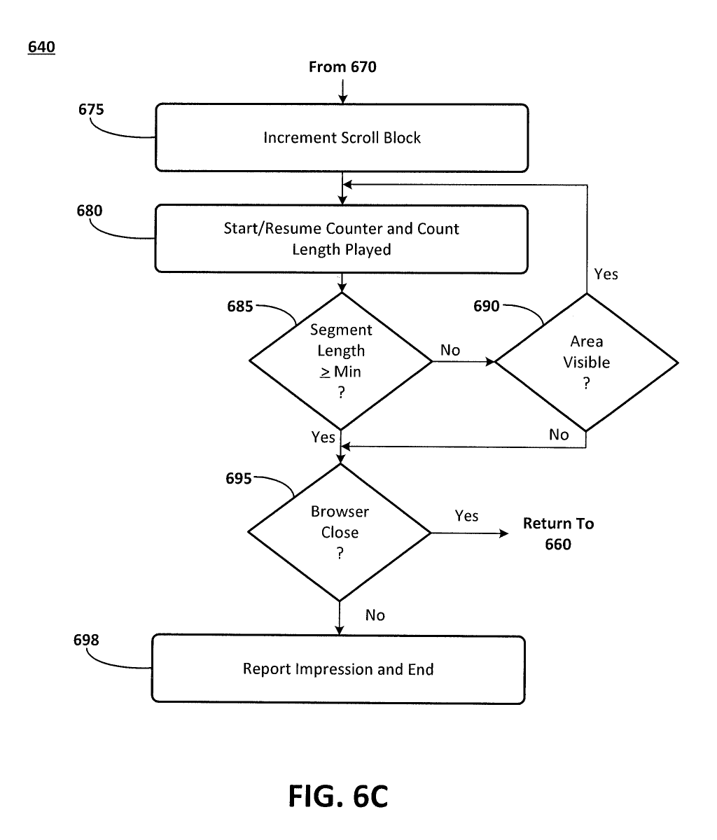

FIGS. 6A-6C are flowcharts illustrating example processes for content segment delayed behavior. The flowcharts are based on the system 200 of FIG. 5A. FIG. 6A illustrates process 600, which is executed using the remote components 202 of FIG. 5A, and which begins in block 605 when a Web page operator defines one or more designated areas for Web page 30. In block 610 the operator embeds a code segment in each of the designated areas. The embedded code segment may include a first instruction to retrieve the identified multi-media advertisement from a storage location when the coordinates of the designated area are wholly or substantially within a viewing area of a browser window, a second instruction to render the retrieved multi-media advertisement in the designated area, a third instruction to activate the rendered multi-media advertisement, and a fourth instruction to monitor and report play of the activated multi-media advertisement. In block 615, the ad selection module 275 receives an ad request for a designated area. In block 620, the module 275 then selects and advertisement and links the advertisement to the Web page 30 using an identification in the code segment. In block 625, the report receiving module 280 receives an advertisement played report. In block 630 the segment counting module 290 increments a segment counter. The process 600 then ends.

In an alternative, the process 600 may begin by detecting if the browser 100 accessing the Web page 30 has the capability of delayed behavior of content segments. If delayed content segment behavior is not implemented on the browser 100, the designated area definition module 260 may operate to push the local components 201 to the media device 62 for plug-in to the browser 100. In an embodiment, the module 260 may first transmit a request message to install the local components 201 as a plug-in to the browser 100.

FIGS. 6B and 6C show delayed behavior content segment process 640 as implemented using the local components 201. In block 645, process 600 begins when the browser 100 access Web page 30 and initiates action to load and render the contents of the Web page 30. In block 650 the coordinate tracking module 210 detects any Web page designated areas of the Web page 30. The module 210 may detect such designated areas by detecting the code segment 35 embedded in the designated area. The module 210 interprets the code, including the coordinates of the designated area relative to a reference point on the Web page 30, and a pointer or link to the storage locale of the content segment, in this case to the local cache 110, and the content segment ID. In block 655, the content segment storage and fetch module 220 stores content segments that are designated for delayed behavior in the cache 110. In an embodiment, the entire delayed behavior content segment is loaded into the cache 110 with the corresponding Web page 30. In block 660, the coordinate tracking module 210 tracks the coordinates of any designated areas on the Web page whose content segment is cached in the cache 110 relative to the coordinates of the browser window 101 and the display 120 as the viewer 66 scrolls the browser window 101. When these coordinates coincide, or substantially coincide, the module 210 reads the code segment 35 embedded in the designated area and sends a message to render the associated content segment. In an embodiment, with each operation of the scrolling function, the module determines, block 665, if the designated area is wholly or substantially visible in the browser window 101. In another embodiment, the module 210 executes this same determination when the browser minimize and maximize functions are executed. Note that in blocks 645-665, should a designated area be determined to be immediately viewable in the browser window 101 (e.g., without any scrolling or maximizing operation of the browser window 101), the associated content segment may be rendered with the initial rendering of the Web page 30. In block 665, if the designated area is not wholly or substantially visible in the browser window 101, the process 640 returns to block 660. In block 665, if the designated area is wholly or substantially visible in the browser window 101, the process 640 moves to block 670.

In block 670 the content segment storage and fetch module 220 retrieves the content segment from the cache 110 and the browser 100 renders the retrieved content segment in the designated area and activates the content segment (e.g., begins playing the video/audio content). In block 675, coincident with activating the content segment, the scroll block module 230 prevents scrolling or minimizing the browser window 101. This scroll lock may be implemented for the entire length of the video, audio, or animated content of the content segment, or for a pre-determined time that is less than the entire length. The scroll block module 230 does not, however prevent closing the browser 100 or opening a new tab that may obscure the activated content segment in the browser window 101. However, closing the browser 100 or obscuring the content segment may be detected by the impression counting/reporting module 250.

In block 680, the impression counting/reporting module 250 begins incrementing (or as described below, resumes) a counter to determine if the played length of the content segment (video, audio, animation) has met the requirements to count as an impression. In block 685, the module 250 determines if the played length is greater than the required minimum length. If the designated area is obscured (by opening of a new tab, minimizing, or scrolling), the module 250 stops counting. In an embodiment, the module 250 may send a command to the browser 100 to stop playing the content segment. In another embodiment, the browser 100 may continue playing the content segment. If the designated area subsequently is “visible” (by scrolling, maximizing, or closing a tab) the module 250 may direct resumption of playing the content segment and may resume counting. Thus, in block 685, if the segment played length is not greater than or equal to the minimum required length, the process moves to block 690. In block 690, the module 250 coordinate tracking module 210 signals the module 250 as to whether the designated area remains visible. In block 690, if the designated area is visible, the process 640 returns to block 680. In block 680, if the content segment resumes playing, the counter may resume. However, if in block 690, the designated area is not visible, the process 640 moves to block 695.

In block 685, if the played segment length is greater than or equal to the minimum required length, the process 640 moves to block 695. In block 695, the module 250 determines if the browser 100 has received a close command. If the browser 100 is open, the process 640 moves to block 660. If the browser 100 has received a close command, the process 640 moves to block 698 and the module 250 reports any recorded impressions and the process 640 then ends. In an alternative, the module 250 may record impressions as they occur rather than waiting for the browser 100 to receive a close command. In another alternative, the browser 100 may report impressions when the browser 100 receives a command to navigate away from the Web page 30.

Certain of the devices shown in FIGS. 1, 4, and 5A-5D include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAM) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a flow chart and accompanying description to illustrate the embodiments represented in FIGS. 6A-6C. The disclosed devices, components, and systems contemplate using or implementing any suitable technique for performing the steps illustrated. Thus, FIGS. 6A-6C are for illustration purposes only and the described or similar steps may be performed at any appropriate time, including concurrently, individually, or in combination. In addition, many of the steps in the flow chart may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices. The computer readable storage medium does not include a transitory signal.

The herein disclosed methods can be implemented as operations performed by a processor on data stored on one or more computer-readable storage devices or received from other sources.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

1. A method, implemented by a processor, for delayed behavior of content segments on a resource, comprising:
defining within a Web page for display by a browser application, using the processor, coordinates of a designated area of the Web page relative to a reference on the Web page;
embedding, using the processor, a delayed behavior content segment code in the designated area, the delayed behavior content segment code comprising a first instruction to retrieve a multi-media advertisement from a storage location when the coordinates of the designated area correspond to coordinates of a browser window, a second instruction to render the retrieved multi-media advertisement in the designated area, and a third instruction to activate the retrieved multi-media advertisement when the defined coordinates of the designated area correspond to coordinates of a window of the browser application, and a fourth instruction to monitor and report play of the activated multi-media advertisement;
receiving, using the processor, a request for the multi-media advertisement;
in fulfillment of the request, receiving, using the processor, an identification of the multi-media advertisement to be served in the designated area;
initiating delayed behavior of the multi-media advertisement; and
receiving a multi-media advertisement played message indicating a length of time the multi-media advertisement played.

2. (canceled)

3. (canceled)

4. (canceled)

5. The method of claim 1, further comprising:
when the browser application accesses the document, determining if the browser application includes delayed content segment behavior programming; and
if the browser does not include the programming, pushing the programming to the browser application for installation as a browser plug-in.

6. A method implemented on a processor for delayed behavior of content segments at a resource, comprising:
accessing, by the processor, the resource;
identifying, by the processor, coordinates of a designated area at the resource relative to a reference in the resource for serving a cached delayed behavior content segment;
receiving, by the processor, a link to the cached delayed behavior content segment;
rendering, by the processor, the resource including the link to the cached delayed behavior content segment;
determining, by the processor, when the coordinates of the designated area correspond to coordinates of a window of an application displaying the rendered resource;
retrieving, rendering, and activating, by the processor, the delayed behavior content segment in the designated area of the resource, responsive to the determination that the coordinates of the designated area correspond to coordinates of the window;
determining, by the processor, a play length of the activated delayed behavior content segment; and
reporting, by the processor, the play length.

7. The method of claim 6, further comprising receiving and installing, by the processor, delayed behavior content segment programming with the access to the resource.

8. The method of claim 6, wherein the resource is an Internet Web page and the Web page is accessed by a browser, and wherein the method further comprises blocking, by the processor, scrolling of a Web page window during playing of the delayed behavior content segment.

9. The method of claim 6, wherein reporting the play length comprises determining, by the processor, that the play length exceeds a minimum length.

10. The method of claim 9, wherein reporting the play length comprises reporting the play length when the processor determines the play length.

11. The method of claim 9, wherein reporting the play length comprises reporting the play length when the browser leaves the Web page.

12. The method of claim 9, further comprising:
monitoring, by the processor, coordinates of the designated area in comparison to coordinates of the browser window; and
pausing the play of the delayed behavior content segment if the coordinates of the designated area do not correspond to coordinates of the browser window.

13. The method of claim 6, further comprising:
storing the delayed behavior content segment in a cache local to the processor; and
retrieving the delayed behavior content segment from the cache local to the processor.

14. A non-transitory computer readable storage medium having encoded thereon a program of instructions executed by a processor for delayed activation of a content segment at an Internet Web page, wherein execution of the program of instructions by the processor causes the processor to:
access the Web page;
identify a designated area at the Web page for serving a delayed activation content segment, the designated area having a first set of coordinates relative to a reference on the Web page;
receive, with contents of the Web page, a link to the delayed activation content segment;
render the Web page including the link to the cached delayed rendering content segment;
determine when the first set of coordinates of the designated area correspond to a second set of coordinates of a browser window;
automatically retrieve, render, and activate the delayed activation content segment in the designated area of the resource, responsive to the determination that the first set of coordinates of the designated area correspond to the second set of coordinates of the browser window;
determine a play length of the activated delayed activation content segment; and
report the play length.

15. The computer readable storage medium of claim 14, wherein execution of the program of instructions by the processor causes the processor to cache the delayed activation content segment in a memory local to the processor.

16. The computer readable storage medium of claim 14, wherein the delayed activation content segment is cached in a Web cache remote from the processor, and wherein execution of the program of instructions by the processor causes the processor to
retrieve the delayed activation content segment from the Web cache when the first set of coordinates of the designated area correspond to the second set of coordinates of the browser window, and
render and activate the retrieved delayed rendering content segment.

17. A delayed behavior content segment system comprising:
a device comprising a display and a processor executing a browser application and a content segment storage and fetch module;
wherein the content segment storage and fetch module is configured to:
receive a request from the browser application to access an Internet Web page having a designated area identified by a first set of coordinates of the Web page relative to a reference on the Web page, for serving and displaying multi-media advertisements;
embed a code segment in the designated area, the code segment including:
a first instruction to retrieve the identified multi-media advertisement from a storage location when the first set of coordinates of the designated area correspond to the second set of coordinates of the window of the browser application,
a second instruction to render the retrieved multi-media advertisement in the designated area, responsive to the first set of coordinates corresponding to the second set of coordinates,
a third instruction to activate the rendered multi-media advertisement, responsive to the first set of coordinates corresponding to the second set of coordinates, and
a fourth instruction to monitor and report play of the activated multi-media advertisement;
send a request for multi-media advertisements to serve in the designated area;
in fulfillment of the request, receive an identification of a multi-media advertisement to be served in the designated area;
supply the identification of the multi-media advertisement and the Web site to the browser;
supply the multi-media advertisement for caching and delayed activation at the Web page, the delayed activation activated responsive to a determination that the first set of coordinates of the designated area correspond to a second set of coordinates of a window of the browser application; and
in response to playing the multi-media advertisement at the browser, receive from the browser a multi-media advertisement played message.

18. The system of claim 17, wherein the advertisement played message indicates a length of time the multi-media advertisement played.

19. (canceled)

20. (canceled)
